(19) United States
(12) Patent Application Publication
(10) Pub. No.: US 2006/0140109 A1
(43) Pub. Date: Jun. 29, 2006

(54) Method and system for joint mode and guard interval detection

(75) Inventor: Che-Li Lin, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/024,162

(22) Filed: Dec. 28, 2004

(51) Int. Cl. H04J 11/00

(52) U.S. Cl. 370/208

(57) ABSTRACT

A method and system for guard interval size and mode detection of a DVB signal. The detection system comprises guard interval detection systems (GIDS), each corresponding to a mode and performing parallel search for the guard interval size based on the OFDM symbol period of the mode. A correlation calculator of a GIDS calculates a correlation signal corresponding to each guard interval size. Characteristics such as maximum value, number of points above a threshold, and a maximum value position in a sample period for each correlation signal are determined and compared, and a valid guard interval size is selected according to the determined characteristics. A mode information combine block retrieves and analyses the detection result from the GIDS.

### BACKGROUND

The invention relates to digital television (DTV) systems, more specifically to joint detection methods and systems for detecting mode and guard interval size in a received Orthogonal Frequency Division Multiplexing (OFDM) signal.

Digital Video Broadcasting-Terrestrial (DVB-T) is a standard for wireless broadcast of video signals using OFDM with concatenated error coding. OFDM is a multi-carrier communication scheme for data transmission over multi-path channels. Information transmitted over different carriers can be properly separated, as the carriers of OFDM symbols are orthogonal to each other.

Inter-symbol interference (ISI) induced by multi-path channels can be minimized by including a cyclic prefix guard interval in each of the active OFDM symbols. The guard interval of a current active symbol is a tail portion of a previous symbol repeated before the current active symbol. Reflections of the previous symbol can be completely removed and the orthogonal feature can be preserved if the guard interval is longer than the maximum channel delay. The duration of the guard interval is flexible as the presence of the guard interval reduces the transmission channel efficiency. The size of the guard interval is thus selected in accordance with transmission quality and conditions so that a desired tradeoff between ISI mitigation capability and channel capacity can be obtained.

The DVB-T or Digital Video Broadcasting-Handheld (DVB-H) systems also support flexible modes of operation, which define different OFDM symbol sizes in order to provide adequate service quality under all kinds of channel conditions. Three modes provided in current DTV specifications are 2K mode, 4K mode, and 8K mode, and the OFDM symbol sizes are 2048, 4096, and 8192 respectively. The 2K mode is suitable for single transmitter operation and for small Single Frequency Networks (SFN) with limited transmitter distances. The 8K mode can be used in environments with long multi-path delay, and is suitable for both signal transmitter operation and SFN networks. The cell size accommodated by the 8K mode is thus bigger than the other two modes.

The mode of operation and the guard interval size of a DVB signal are unknown when the DVB signal is received by a DVB-T receiver. The DVB-T receiver thus requires a blind detection mechanism to determine the actual mode and the guard interval size in order to receive other system parameters for subsequent data receiving operations.

The DVB signal is organized in frames, each having 68 OFDM symbols. Each OFDM symbol comprises a useful part and a guard interval, and is constituted by a set of 6817 carriers in the 8K mode, 3409 carriers in the 4K mode, or 1705 carriers in the 2K mode. The unused carriers not carrying OFDM symbols are used as guard bands. There are four different guard interval sizes, N/32, N/16, N/8, and, N/4 that may be used for adapting to different transmission conditions, where N is the length of the useful part referred to as the OFDM symbol period, N=2048 for the 2K mode, N=4096 for the 4K mode, and N=8192 for the 8K mode. There are four potential guard interval sizes and three potential modes that can be used to transmit a DVB signal. Thus, a DVB-T receiver must be capable of rapidly determining one of the 3*4=12 combinations while receiving the DVB signal.

### SUMMARY

An embodiments of the invention provides a method and system for guard interval size detection and mode detection, among m guard interval sizes and n modes in a DVB signal. Each mode defines a specific OFDM symbol period. The method comprises the following steps. A DVB signal is received to form a digital signal, and preliminary correlation signals for each mode are calculated therefrom, based on the OFDM symbol period of the mode respectively. Search procedures for guard interval sizes of each mode are synchronously processed, and a search result is output, to indicate the valid guard interval size and the mode. For each mode, the preliminary correlation signal is summed based on a function of each of the m guard interval sizes to generate a correlation signal. A maximum value N_{M}, a number of points above a threshold N_{P}, and a maximum value position N_{I} in a sample period W for each correlation signal is determined, and the guard interval size is determined as the valid guard interval size according to the values N_{M}, N_{P}, N_{I} of each correlation signal.

Another embodiment of the invention provides a system for detecting guard interval size and mode among m potential guard interval sizes and n potential modes in a DVB signal. The system comprises an analog to digital converter (ADC), n guard interval detection systems (GIDS), and a mode information combine block (MICB). The ADC digitizes the DVB signal to form a digital signal and provides the digital signal to the GIDS. Each GIDS corresponding to one of the n modes performs parallel search for the guard interval size. The MICB coupled to the GIDS monitors if any of the GIDS detects a valid guard interval size. Once a GIDS detects the valid guard interval size, the MICB outputs the valid guard interval size and the mode corresponding to the GIDS as the detection result.

Embodiments of a GIDS comprise a correlation calculator, a CE, and an information combiner. The correlation calculator calculates a preliminary correlation signal from the digital signal based on the OFDM symbol period of the corresponding mode, and generates a correlation signal for each of the m guard interval sizes by summing the preliminary correlation signal based on a function of the guard interval size. The characteristic extractor (CE) determines a maximum value N_{M}, a number of points above a threshold N_{P}, and a maximum value position N_{I} in a sample period W for each correlation signal generated by the correlation calculator. The information combiner determines the guard interval size as the valid guard interval size from one of the m guard interval sizes according to the values N_{M}, N_{P}, and N_{I} of each correlation signal.

In some embodiments, the information combiner of each GIDS chooses the guard interval size by comparing the values N_{M} and N_{P} of the correlation signals, and checks validity of the chosen guard interval size based on the maximum value position N_{I} obtained in a current and a previous sample period. The chosen guard interval size is determined to be the valid guard interval size if the corresponding maximum value position N_{I} occurs periodically.

Each of the GIDS may further comprise a confirmation block coupled to the information combiner for counting a number of times the chosen guard interval size passes the validity check, comparing the counted number to a confirm threshold, and confirming the chosen guard interval size as the valid guard interval size if the counting number exceeds the confirm threshold. The confirmation block may also generate an invalid message if the corresponding maximum value position N_{I} of the determined guard interval size does not occur periodically. The confirmation block counts the number of invalid messages, compares the counted number to an invalid threshold. If the counting number exceeds the invalid threshold, the confirmation block outputs an invalidity flag to the MICB. The MICB reports “no valid DVB signal detected” when all n GIDS confirm invalidities.

### DESCRIPTION OF THE DRAWINGS

The methods and systems for detecting a guard interval size can be more fully understood by reading the subsequent detailed description in conjunction with the examples and references made to the accompanying drawings, wherein:

FIG. 1 illustrates an embodiment of a detection system for mode and guard interval size detection in DVB-T system.

FIGS. 2A˜2B illustrate another embodiment of a detection system.

FIG. 3 illustrates exemplary correlation signals after moving sum and absolute value calculations, where N_{GI}=N/8.

FIG. 4 is a block diagram illustrating an embodiment of a CE.

FIG. 5 is a block diagram illustrating an embodiment of an information combiner.

FIG. 6 is a flowchart showing an embodiment of validation check according to the maximum value positions.

FIG. 7 shows exemplary correlation signals under two timing conditions.

FIG. 8 is a flowchart showing an embodiment of a confirmation block.

FIG. 9 is a flowchart showing an embodiment of a mode information combine block.

### DETAILED DESCRIPTION

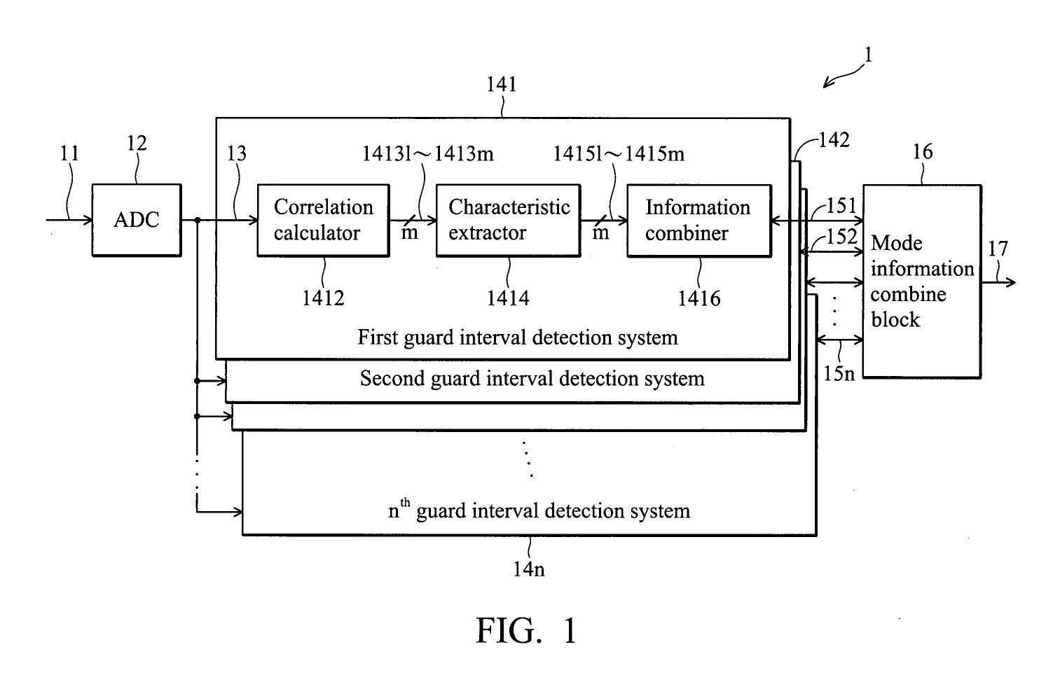

FIG. 1 shows an exemplary detection system 1 in a receiver for detecting guard interval size and mode of a DVB signal. The detection system 1 comprises an analog to digital converter (ADC) 12, n guard interval detection systems (GIDS) 141˜14n, and a mode information combine block (MICB) 16. Each of the GIDS 141 to 14n is specifically designed for different guard interval size detection, performing parallel search for the guard interval size and mode of the DVB signal. For example, the first GIDS 141 detects 2K mode, the second GIDS 142 detects 4K mode, and so on. The ADC 12 converts a DVB signal 11 into a digital signal 13, and provides the digital signal 13 to each of the GIDS 141˜14n. The validity flags 151˜15n corresponding to the GIDS 141˜14n are provided to the MICB 16. For a valid DVB signal, the MICB receives the validity flags 151 to 15n to determine the most possible mode and guard interval, and when the validity of the determination is further confirmed, the MICB 16 informs the GIDS to terminate the parallel search.

In FIG. 1, each GIDS 141˜14n comprises a correlation calculator 1412, a characteristic extractor (CE) 1414, and an information combiner 1416. For example, in GIDS 141, the correlation calculator 1412 computes a preliminary correlation signal by self-correlating the digital signal 13, and generates m correlation signals 14131˜1413m corresponding to the m guard interval sizes. The CE 1414 determines m sets of characteristics 14151˜1415m in a sample period W for each correlation signal 14131˜1413m, comprising maximum value N_{M}, number of points above a threshold N_{P}, and maximum value position N_{I}. The information combiner 1416 compares the maximum value N_{M} and number of points above a threshold N_{P} to detect the guard interval size, and confirms the validity of detection according to the maximum value position N_{I}. Additionally, the correlation signals 14131˜1413m can be sent to a metric block (not shown) before output to the CEs 1414. The metric block generates metric values for each correlation signal, and the CE 1414 determines the characteristics based thereon. The MICB 16 receives all the validity flags 151˜15n, therefore the guard interval size and mode of the DVB signal can be determined based thereon.

In some embodiments of a DVB-T system, the transmitter may adopt one of the four (m=4) guard interval sizes N/32, N/16, N/8, or N/4 in a DVB signal among three modes (n=3) comprising 2K mode N=2048, 8K mode N=4096, and 8K mode N=8192. N is the length of the useful data in a symbol, which is also referred to as the OFDM symbol period. The detection system thus requires three GIDS 141˜143 for 2K, 4K and 8K modes respectively. For example, when a DVB signal is found to be valid by a 4K mode GIDS 142 with guard interval size N/16, a validity flag is delivered to the MICB 16, and since the object is achieved, the remaining GIDS (2K and 8K mode GIDSs) are informed to terminate the search procedures by the MICB.

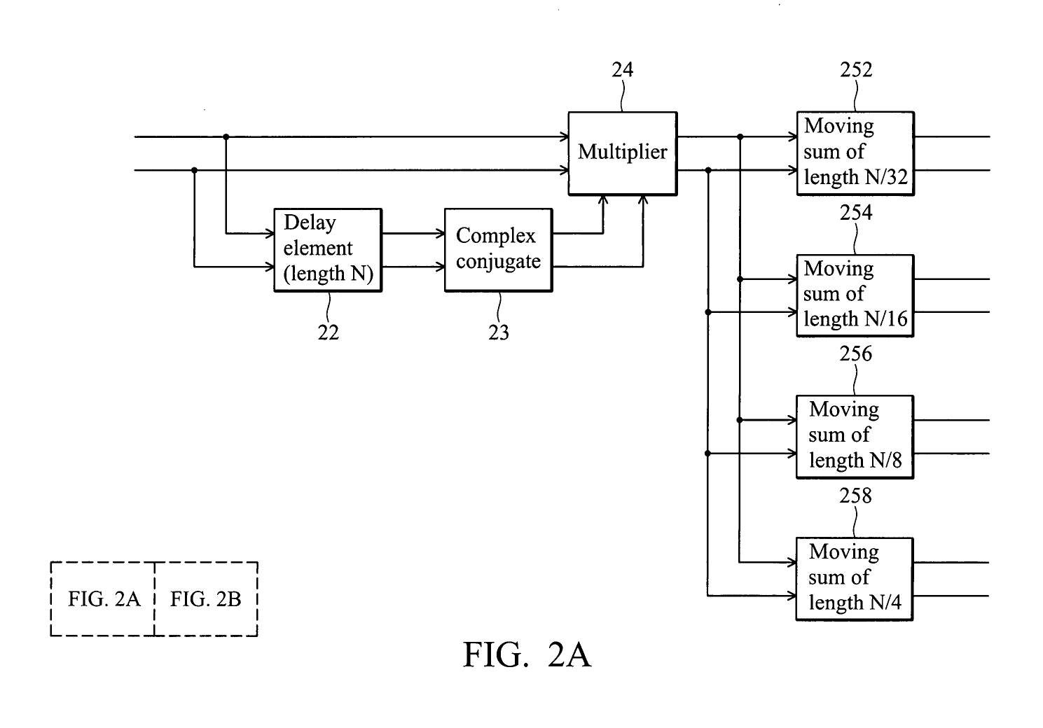

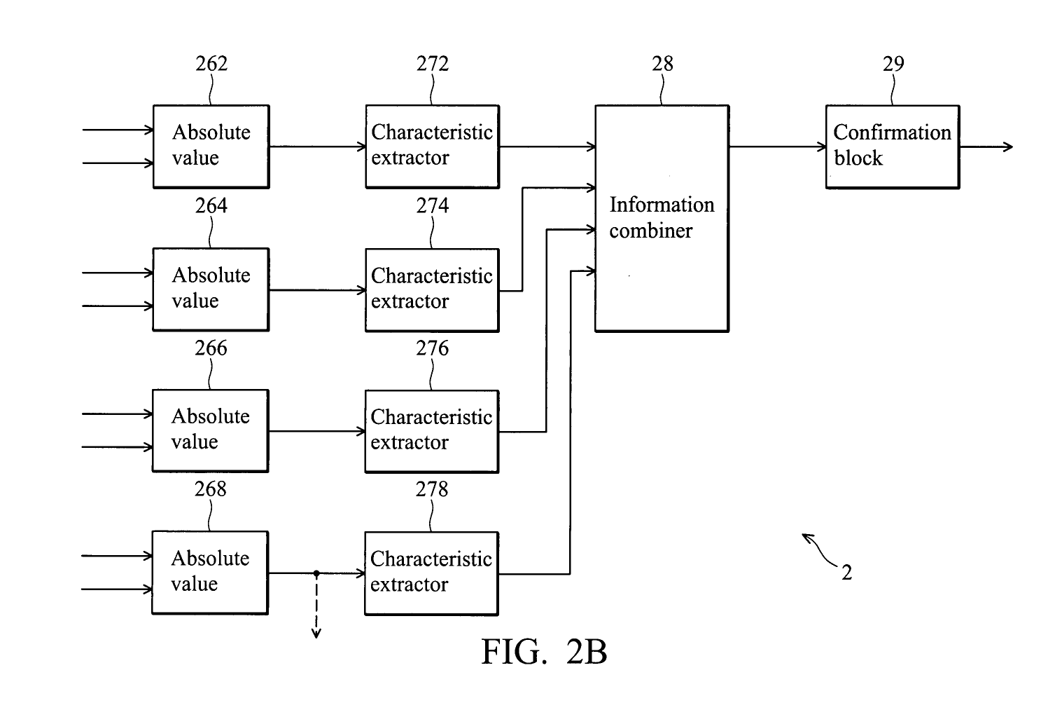

FIGS. 2A˜2B illustrate an embodiment of a GIDS 2 for determining the guard interval size by a presuming mode with corresponding OFDM symbol period N. A digital signal 21 is received from a radio frequency (RF) or an intermediate frequency (IF) module (not shown), converted by an ADC (not shown) of the receiver, and provided to a delay element 22 and a multiplier 24. The multiplier 24 multiplies the digital signal 21 and a delayed digital signal obtained by passing the digital signal through the delay element 22 and a complex conjugate unit 23, such that a preliminary correlation signal is formed. The preliminary correlation signal is capable of indicating the similarity between the digital signal 21 and the delayed digital signal. The preliminary correlation signal is then output to four moving sum blocks 252˜258 and four absolute value blocks 262˜268 to obtain four correlation signals, wherein each correlation signal is computed by a corresponding presuming guard interval sizes.

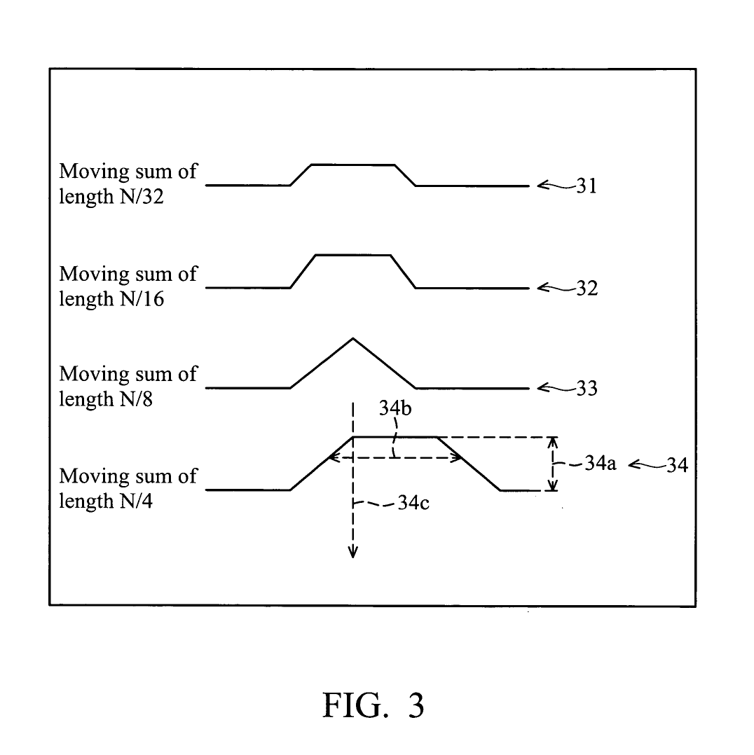

FIG. 3 shows exemplary correlation signals generated from the moving sum blocks 252˜258 and absolute value blocks 262˜268. In FIG. 3, the actual guard interval size is N/8, which is unknown to the GIDS 2. The correlation signals 31˜34 show the moving sums of the preliminary correlation signal when the accumulated lengths are N/32, N/16, N/8, N/4 respectively. As a result, a sharp peak occurs in the correlation signal 33 that indicates a high correlation between the digital signal and the delayed digital signal. Conversely, the remaining correlation signals 31, 32, and 34 don't appear to be valid, thus the guard interval size can be confirmed to be N/8. Thereafter, in FIGS. 2A and 2B, the CEs 272˜278 receive the correlation signals output from the corresponding absolute value blocks 262˜268 to extract characteristics therefrom, including maximum value N_{M}, maximum value position N_{I}, and a number of points above a threshold N_{P} of each symbol.

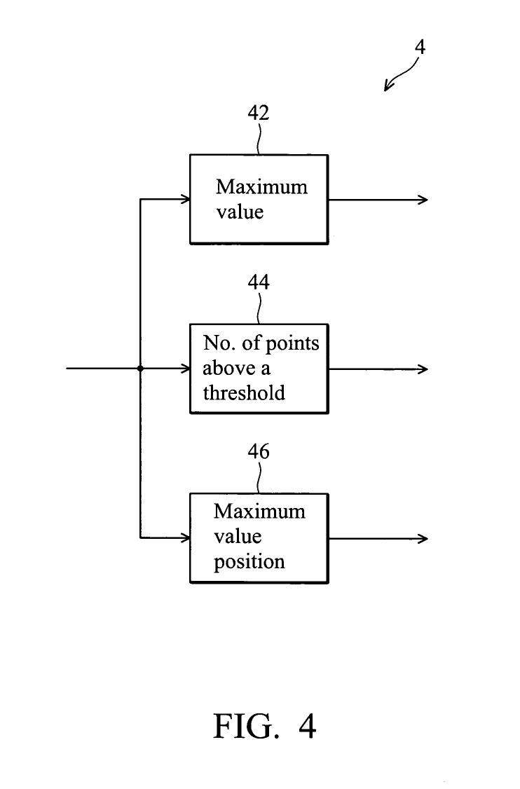

FIG. 4 is a block diagram illustrating an exemplary characteristic extractor (CE) 4, comprising three blocks 42, 44, and 46 for determining maximum value N_{M}, number of points above a threshold N_{P}, and maximum value position N_{I} respectively. In FIG. 3, the physical meaning of maximum value (N_{M}) 34a, maximum value position (N_{I}) 34c, and number of points above a threshold (N_{P}) 34b are shown. The threshold can be a level generated by multiplying an average of at least one preceding maximum value N_{M} and a value less than 1, for example 0.7. If the accumulated length is identical to the actual guard interval size, the extracted maximum value N_{M} will appear to be exceedingly large, and the extracted number of points above the threshold N_{P} is expected to be rare, thus the obviousness can be measured easily. As shown in FIG. 3, since the actual guard interval size is N/8, and the correlation signal 33 (obtained by the moving sum of N/8) has a sharp peak with a large maximum value and a small number of points above the threshold. In comparison, the other three correlation signals 31, 32, and 34 do not show a sharp peak, and numbers of points above the thresholds are large in comparison to the correlation signal 33. Additionally, the maximum value positions N_{I} extracted from the correlation signal obtained by the actual accumulated length are expected to occur periodically, and therefore, the maximum value positions N_{I} can be an indicator for examining the validity of the determined guard interval size.

In FIGS. 2A˜2B, the CEs 272˜278 provide the extracted characteristics to the information combiner 28 separately, and the information combiner 28 determines the guard interval size according to the maximum values N_{M} and the numbers of points above the threshold N_{P}. The information combiner 28 also checks the validity of the determined guard interval size according to the maximum value positions N_{I}. A confirmation block 29 further confirms the guard interval determined by the information combiner 28 in order to improve the system accuracy. In the confirmation block 29, the value of the OFDM symbol period N presumed by the GIDS is deemed invalid if the information combiner 28 reports the invalidity too many times. For a DVB signal, only one of the GIDS 141˜14n can find the valid value.

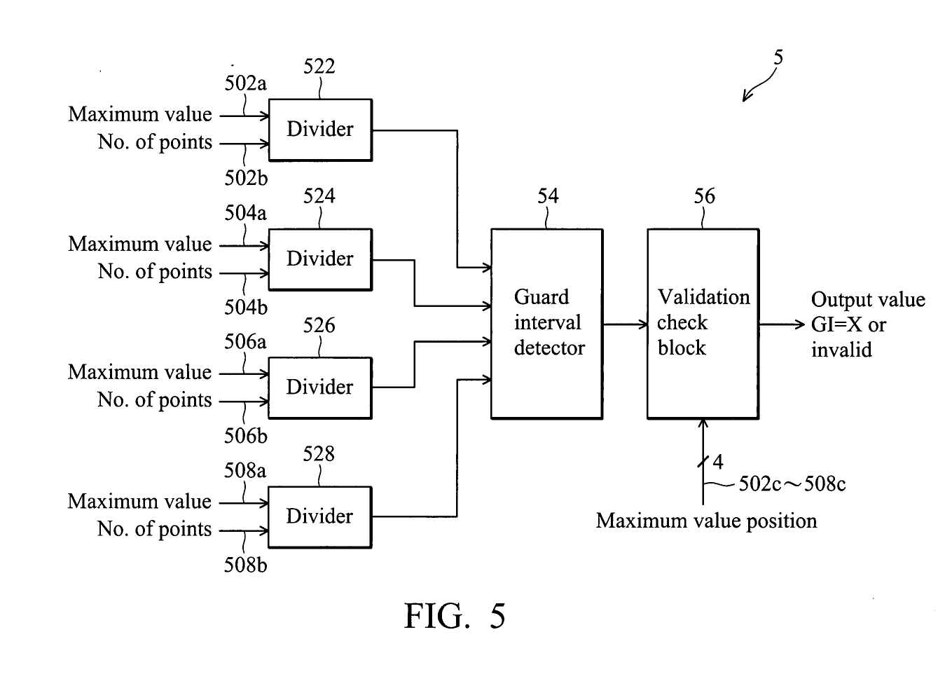

FIG. 5 is a block diagram illustrating an embodiment of an information combiner 5. The information combiner 5 comprises four dividers 522˜528, a guard interval detector 54, and a validation check block 56. Each divider 522˜528 obtains maximum value 502a, 504a, 506a, and 508a, and number of points above a threshold 502b, 504b, 506b, and 508b, from corresponding CEs, and calculates ratio between the maximum value N_{M} and the number of points N_{P} (N_{M}/N_{P}). The guard interval detector 54 thus receives four ratios calculated by the dividers 522˜528 respectively and determines the guard interval size by selecting a greatest ratio among the four ratios. The validation check block 56 retrieves four maximum value positions N_{I} 502c, 504c, 506c, and 508c from the four CEs, and checks whether the maximum value position N_{I} corresponding to the greatest ratio is a valid position. The maximum value positions N_{I} are expected to be periodical and the period is expected to be N+N_{GI} where N_{GI} is the guard interval size, and I is an index for various guard interval sizes.

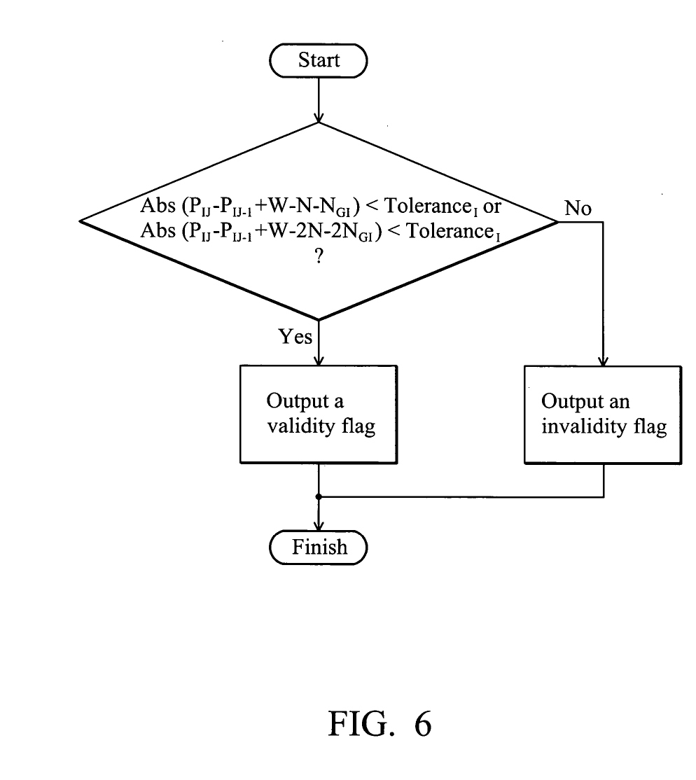

FIG. 6 is a flowchart of an exemplary validation check block examining whether a maximum value position N_{I} is periodical. The sample period W for each CE to extract a maximum value N_{M}, maximum value position N_{I}, and number of points N_{P} is a flexible window size for the CE. Sample period W must be greater than the maximum potential period (N+N_{GI}), and in this case, the maximum guard interval size is N/4, so sample period W must be greater than 1.25 times the OFDM symbol period (W>1.25N). In this case, we set W=1.5N for example. The validation check block compares calculated errors with preset tolerance values. The calculated errors are calculated as following:
Error1=Abs[(P_{IJ}+W)−P_{IJ-1}−N−N_{GI}]; [1]
Error2=Abs[(P_{IJ}+W)−P_{IJ-1}−2N−2N_{GI}]; [2]

Where I is an index for the various guard interval sizes, I=1 for guard interval N_{GI}=N/32, I=2 for N_{GI}=N/16, I=3 for N_{GI}=N/8, and I=4 for N_{GI}=N/4, and J denotes the J^{th} result for maximum value position, for each window size W, one result P_{IJ} corresponding to each N_{GI} is obtained. N_{GI} denotes the guard interval size for guard interval I, for example, N_{G1}=N/32, N_{G2}=N/16, N_{G3}=N/8 and N_{G4}=N/4. When two potential timing conditions are considered, Error1 and Error2 calculated by Equations [1] and [2], each compares the distances between two extracted maximum values to one symbol period and two symbol periods respectively.

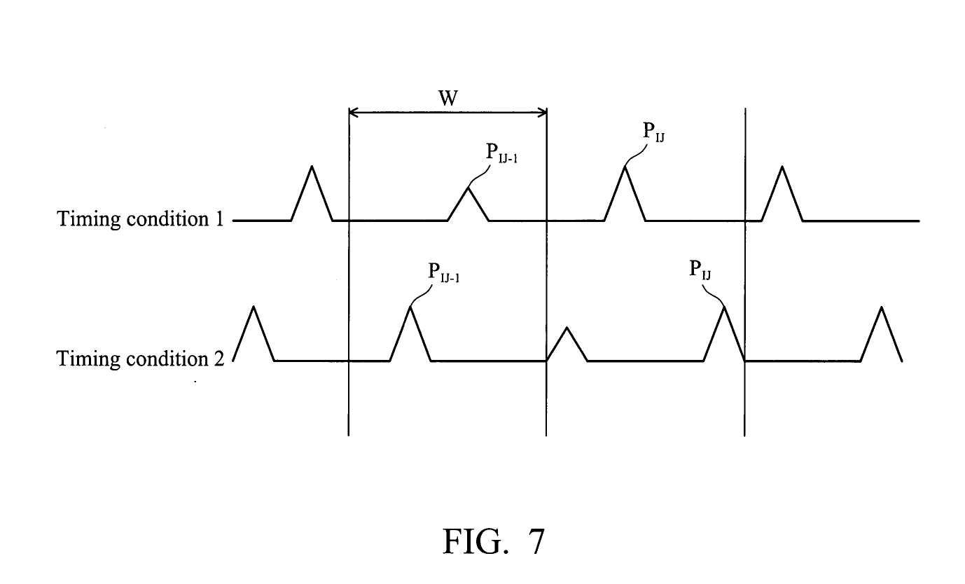

FIG. 7 shows exemplary correlation signals for depicting the two timing conditions. In timing condition 1, the distance between two consecutive maximum value positions N_{I} is supposed to equal one symbol period (N+N_{GI}), whereas the distance between two consecutive maximum value positions N_{I} is supposed to equal two symbol periods (2N+2N_{GI}) under timing condition 2. Either error1 or error2 calculated by Equations [1] and [2] must be less than a preset tolerance, or else the determined guard interval size is regarded as invalid.

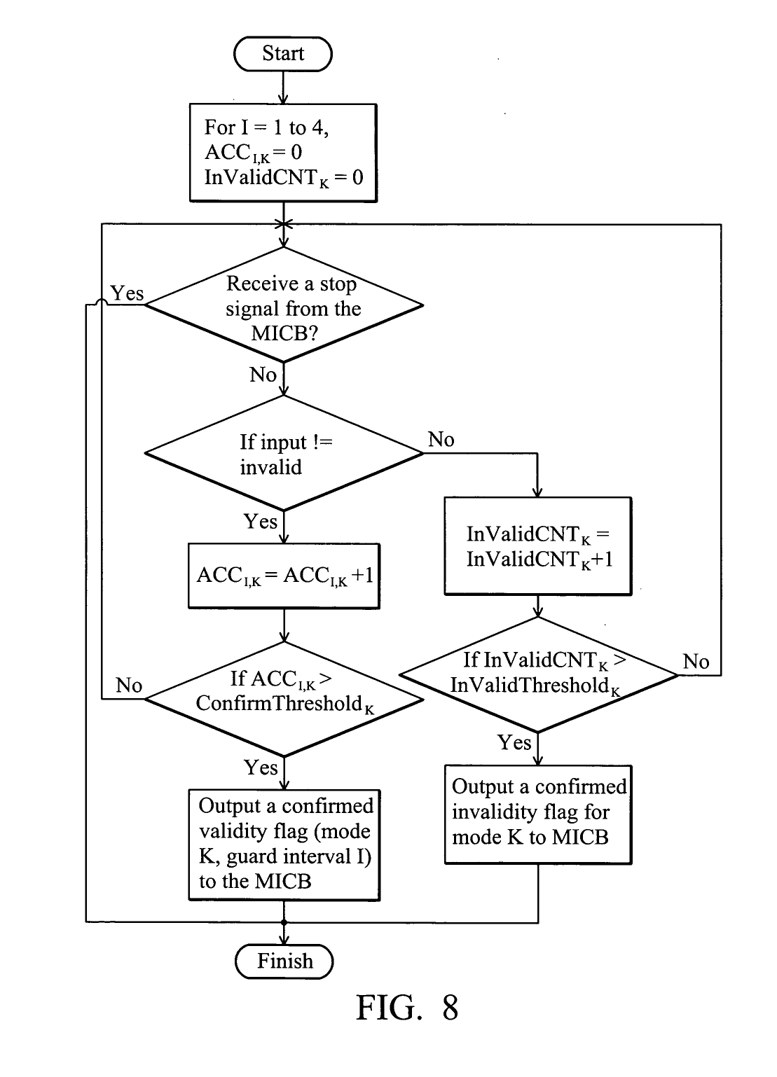

FIG. 8 is a flowchart illustrating execution of confirmation block procedures. The MICB controls the GIDS to either continue or terminate the detection based on validity flags on each confirmation block in the GIDS. The confirmation blocks of each GIDS of mode K receive outputs from the corresponding information combiners to count the valid numbers and invalid numbers thereof. The DVB signal is deemed to be unmatched to period N of mode K if the invalid numbers exceed a predetermined invalid threshold InValidThreshold_{K}, thus the confirmation block outputs an invalidity flag to the MICB. If any of the guard interval size counts exceeds a predetermined confirm threshold ConfirmThreshold_{K}, the confirmation block outputs a confirmed validity flag with the detection result of mode K and the index I to the MICB. The confirmation block can terminate the confirmation procedures early if a stop signal is received from the MICB indicating that the one of the GIDS has already found the guard interval and mode.

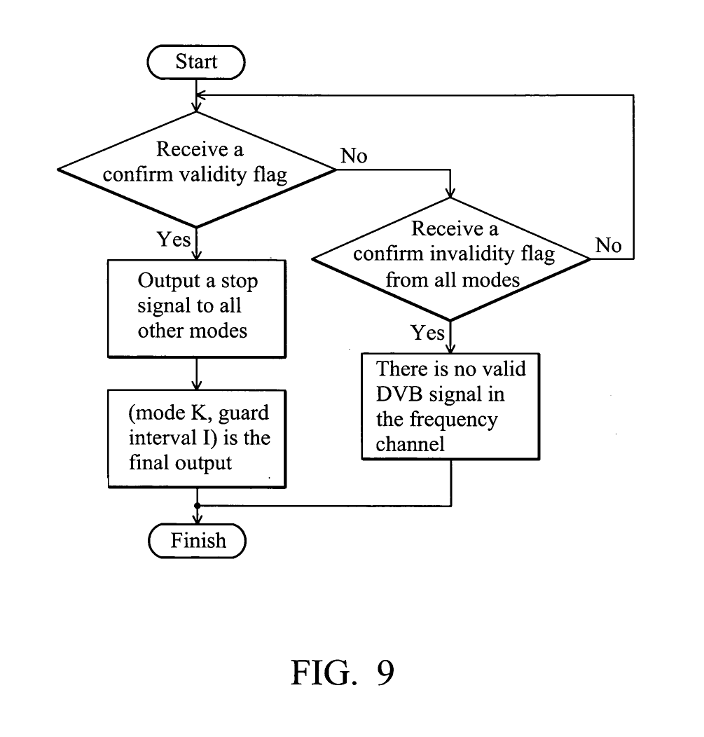

FIG. 9 is a flowchart showing the procedures executed by an exemplary mode information combine block (MICB). The MICB determines whether a confirmed validity flag has been delivered from any of the GIDS, and if the MICB receives the confirmed validity flag, a stop signal is output to all the GIDS corresponding to other modes, and the mode and guard interval size can be determined according to the confirmed validity flag. The MICB determines that there is no valid DVB signal in the frequency channel if all the GIDS output invalidity flags.

The parallel search performed by each GIDS for detecting the mode and guard interval size has the following advantages. Rather than detecting the mode and guard interval size one by one via a single GIDS, the embodiment described is more efficiency based on parallelism. The GIDS only requires a small storage capacity, thus the memory consumed by the detection system with three GIDS performing parallel search is still conservative in terms of memory usage.

The sample period W of the CEs, information combiners, and confirmation blocks in all the GIDS can be set as 1.5N. The value of OFDM symbol period N is however different according to the corresponding mode, the sample period W can be different for all the modes. In this case, we set W=1.5N for example. The validation check block compares calculated errors with preset tolerance values.

Information exchanged between the MICB and the GIDS is not affected by variation of the sample periods W in the GIDS. The parameters of information combiners and confirmation blocks can also be set differently for different modes to improve system performance. For example, the tolerance value (Tolerance_{I}) for validation checking as shown in FIG. 6 corresponds to a GIDS with a longer OFDM symbol period (such as 8K mode) can be set greater than the tolerance value corresponding to a shorter OFDM symbol period (such as 4K or 2K mode). The confirm threshold and invalid threshold shown in FIG. 8 corresponds to a GIDS with a longer OFDM symbol period can be set to be smaller than the confirm threshold and invalid threshold corresponding to a shorter OFDM symbol period.

While the invention has been described by way of example and in terms of preferred embodiments, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for guard interval size and mode detection of a Digital Video Broadcasting (DVB) signal, wherein the guard interval size comprises m potential varieties and the mode comprises n potential varieties, the DVB signal comprises an OFDM symbol period relating to the mode, the method comprising:
sampling the DVB signal to form a digital signal;
synchronously processing search in n presuming modes, each comprising:
generating a preliminary correlation signal from the digital signal based on a presuming OFDM symbol period relating to the presuming mode;
generating m correlation signals corresponding to m presuming guard interval sizes by summing the preliminary correlation signal based on a function of the presuming guard interval sizes;
determining the maximum value N_{M} and the number of points above a threshold N_{P} in a sample period W for each correlation signal; and
generating m search results based on the maximum value N_{M} and the threshold N_{P} corresponding to each correlation signal;
determining the guard interval size and mode of the DVB signal according to the search results generated in the synchronous search step; and
terminating the synchronous search when the guard interval size and mode of the DVB signal are determined.

2. The method according to claim 1, wherein the maximum value N_{M} and the threshold N_{P} obtained from each correlation signal are determined by obtaining metric values of each correlation signal in the sample period W, searching for a peak among the metric values as the maximum value N_{M}, and counting a number of metric values above the threshold as the threshold N_{P}.

3. The method according to claim 2, wherein the metric values are absolute values of each correlation signal in the sample period W.

4. The method according to claim 1, further comprising locating a maximum value position N_{I} in the sample period.

5. The method according to claim 4, wherein the validity of the presuming guard interval size is determined based on maximum value position N_{I} occurs periodically.

6. The method according to claim 5, wherein the validity of the presuming guard interval size is determined if the corresponding maximum value position N_{I} occurs periodically.

7. The method according to claim 5, wherein the synchronous search further comprises outputting a search result indicating the validity of the presuming guard interval size if the number of the valid presuming guard interval sizes exceeds a confirm threshold.

8. The method according to claim 7, wherein the confirm threshold of a longer OFDM symbol period mode is set to be less than or equal to a shorter OFDM symbol period mode.

9. The method according to claim 1, wherein the sample period W corresponding to each mode is greater than 1.25 times the OFDM symbol period N defined by the mode (W>1.25N).

10. The method according to claim 1, wherein the guard interval size is determined by calculating and comparing a ratio between the maximum value N_{M} and the threshold N_{P} corresponding to each correlation signal.

11. The method according to claim 1, wherein the synchronous search further comprises accumulating an invalid counter if the corresponding maximum value position N_{I} of the presuming guard interval size does not occur periodically.

12. The method according to claim 11, wherein the synchronous search further comprises outputting a search result indicating the invalidity of the presuming guard interval size if the invalid counter exceeds an invalid threshold.

13. The method according to claim 11, wherein the invalid threshold of a longer OFDM symbol period mode is set to be less than or equal to a shorter OFDM symbol period mode.

14. A system for detecting guard interval size and mode of a DVB signal comprising m potential guard interval size varieties and n potential mode varieties, wherein each potential mode defines an OFDM symbol period, comprising:
an analog to digital converter (ADC), sampling the DVB signal to form a digital signal;
n guard interval detection systems (GIDS), obtaining the digital signal from the ADC, synchronously searching the guard interval size thereof, and generating n search results corresponding to n presuming modes respectively, each comprising:
a correlation calculator, generating a preliminary correlation signal from the digital signal based on a presuming OFDM symbol period relating to the presuming mode, and generating m correlation signals corresponding to m presuming guard interval sizes by summing the preliminary correlation signal based on a function of the presuming guard interval sizes;
a characteristic extractor, determining the maximum value N_{M} and the number of points above a threshold N_{P} in a sample period W for each correlation signal; and
an information combiner, determining the validity of the presuming guard interval sizes based on N_{M}, N_{P}, and N_{I} of each correlation signal; and
a mode information combine block, determining the guard interval size and mode of the DVB signal according to the search results generated from the n GIDS; wherein the n GIDS terminate synchronous search when the guard interval size and mode of the DVB signal are determined.

15. The system according to claim 14, wherein each GIDS further comprises a metric value block, obtaining metric values of each correlation signal output from the correlation calculator, and providing the metric values to the characteristic extractor.

16. The system according to claim 15, wherein the metric value block is an absolute value block, obtaining absolute values of each correlation signal in the sample period W.

17. The system according to claim 14, wherein the information combiner of each GIDS determines the validity of the presuming guard interval size by comparing the values N_{M} and N_{P} of the correlation signals, and based on the maximum value position N_{I} obtained in a current and a previous sample period.

18. The system according to claim 17, wherein the validity of the presuming guard interval size is determined if the corresponding maximum value position N_{I} occurs periodically.

19. The system according to claim 17, wherein each GIDS further comprises a confirmation block coupled to the information combiner, outputting a search result indicating the validity of the presuming guard interval size if the number of the valid presuming guard interval sizes exceeds a confirm threshold.

20. The system according to claim 19, wherein the confirm threshold of a longer OFDM symbol period mode is set to be less than or equal to a shorter OFDM symbol period mode.

21. The system according to claim 14, wherein the sample period W corresponding to each mode is greater than 1.25 times the OFDM symbol period N defined by the mode (W>1.25N).

22. The system according to claim 14, wherein the information combiner of each GIDS determines the guard interval size by calculating and comparing a ratio between the maximum value N_{M} and the number of points above the threshold N_{P} corresponding to each correlation signal.

23. The system according to claim 14, wherein each GIDS counts a confirmation block, accumulating an invalid counter if the corresponding maximum value position N_{I} of the presuming guard interval size does not occur periodically.

24. The system according to claim 23, wherein the confirmation block of each GIDS outputs a search result indicating the invalidity of the presuming guard interval size if the invalid counter exceeds an invalid threshold.

25. The system according to claim 24, wherein the invalid threshold of a longer OFDM symbol period mode is set to be less than or equal to a shorter OFDM symbol period mode.
